(19) United States
(12) Patent Application Publication
(10) Pub. No.: US 2024/0037674 A1
(43) Pub. Date: Feb. 1, 2024

(54) INFERENCE AND EXPOSURE OF USER COMMUNICATION PREFERENCES

(71) Applicant: Microsoft Technology Licensing, LLC, Redmond, WA (US)

(72) Inventors: Lars BRENNA, Tromsø (NO); Jan Heier JOHANSEN, Tromsø (NO); Paul Meyer LEVLIN, Tromsø (NO); Ksenja KUSMIN, Tromsø (NO); Simon Thoresen HULT, Oslo (NO); Malgorzata PARUCH, Sola (NO)

(21) Appl. No.: 17/878,548

(22) Filed: Aug. 1, 2022

(51) Int. Cl. G06Q 50/00; H04L 67/1396; H04L 67/306; G06Q 10/10

(52) U.S. Cl. CPC G06Q 50/01; H04L 67/1396; H04L 67/306; G06Q 10/1093

(57) ABSTRACT

A method for detecting and exposing user communication preferences within a communication application includes accessing a user profile datastore to retrieve an inferred communication preference from each of a plurality of user profiles. The method further includes storing, within each of a plurality of contact cards of a communication application, the inferred communication preference downloaded from a corresponding one of the plurality of user profiles in the user profile datastore; detecting, via a user interface of the communication application, a user interaction with a user interface element associated with a select one of the contact cards; and responsive to detecting the user interaction, presenting, on the user interface of the communication application, the inferred communication preference stored within in the select one of the contact cards.

### BACKGROUND

Modern work environments typically facilitate various modes of communication such as voice calls, video conferencing, web-based chat, and email. Although current communication platforms support multi-modal communications that give individuals options for initiating communications, those individuals have little to no control of the format or form of the communications they receive.

### SUMMARY

According to one implementation a method for exposing inferred user communication preferences to other users includes tracking communication activity of a first user conducted in association with a first communication account to a communication application and automatically inferring a communication preference for a communication preference field of a user profile of the first user based on an analysis of the tracked communication activity for the first user. The method further includes transmitting the inferred communication preference of the first user to a user profile datastore that is accessible to multiple instances of the communication application executing on different devices and populating each of multiple contact cards of the communication application with profile information extracted from a corresponding user profile in the profile datastore. The profile information populated into each of the multiple contact cards includes an inferred communication preference for the communication preference field. The method further includes presenting, on a user interface of the communication application, the inferred communication preference stored within a select one of the populated contact cards.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example communication system that infers user communication preferences and exposes those preferences to other users interacting with a communication application.

FIG. 2 illustrates example communication preference field information that may be set for a user and exposed to a user's contacts through a communication application.

FIG. 3 illustrates aspects of another example system that automatically infers user communication preferences and exposes such preferences to other users through a communication application.

FIG. 4 illustrates example communication preferences of a first user displayed on a user interface of a second user while the second user is logged into and interacting with a communication application on a personal device.

FIG. 5 illustrates further example communication preferences of a first user displayed on a user interface of a second user while the second user is logged into and interacting with a communication application on a personal device.

FIG. 6 illustrates example operations for inferring and exposing communication preferences of multiple users.

FIG. 7 illustrates an example schematic of a processing device suitable for implementing aspects of the disclosed technology.

### DETAILED DESCRIPTION

Different users have different preferences regarding modes of communication as well preferred communication content and style. For example, one user may generally prefer the conversational efficiency of spoken communication while another user may prefer email because it is less disruptive in that it allows the recipient to review and respond a time that is convenient for them. These mode of communication preferences may vary based on the parties involved; for example, an individual may prefer to be contacted by phone only by their close contacts; another user may prefer email or use web-based chatting exclusively with individuals internal to their work organizations.

In addition to preferences regarding mode of communication, individual users may also have varied preferences pertaining to communication content and form. In the work environment, some individuals may prefer detail-heavy emails while others may prefer brief summaries of facts and higher-level explanations.

There herein disclosed technology facilitates collection of the above types of individual user communication preferences and exposes these preferences to other users (their contacts), thereby improving user communication experiences by increasing communications compliant with the recipient's preferences.

According to one implementation, the communication systems disclosed herein collect and store personal communication preference data for individual users. In various implementations, various personal communication preferences may be manually provisioned, automatically inferred, or some combination of both through a user's interactions with one or more communication accounts. As used herein, a communication account is a user account to a communication application. To communicate with others through the communication application, the user first logs into their communication account, such as an email account, messaging account, etc. A communication application is an application that supports either single-mode communications (e.g., email) or multimodal communications (e.g., voice call and chat messaging within a single application interface).

In one implementation, the disclosed technology provides for tracking communications sent to and/or from one or more communication accounts of a user. The tracked communications are analyzed to extract (automatically infer) one or more communication preference of the user, such as preferences related to communication mode, message style, or form. Some implementations further support the inference of communication preferences that differ with respect to different contacts and/or characteristics of those contacts (e.g., close contacts v. new contacts or organization-internal contacts v. organization-external contacts). Inferred user preferences are exposed to the user's contacts either automatically or in response to an affirmative user action, such as when a user clicks on a prompt to accept a suggested update to a communication preference maintained with respect to the user's personal profile data.

Collecting an individual user's communication preferences and visually exposing those preferences to others, such as within a contact card of a communication application, can provide users being contacted with a sense of control over the format and/or form of the communications they receive. This, in turn, can improve the user's sense of enjoyment when engaging in such communications because the user does not have to engage in modes of communication they are less comfortable with. Additionally, the foregoing can improve a user's sense of satisfaction in daily work activities due to factors such as improved efficiency and work productivity as a result of fewer work interruptions, more efficient communication, and/or fewer incoming communications that the user perceives as being a waste of their time.

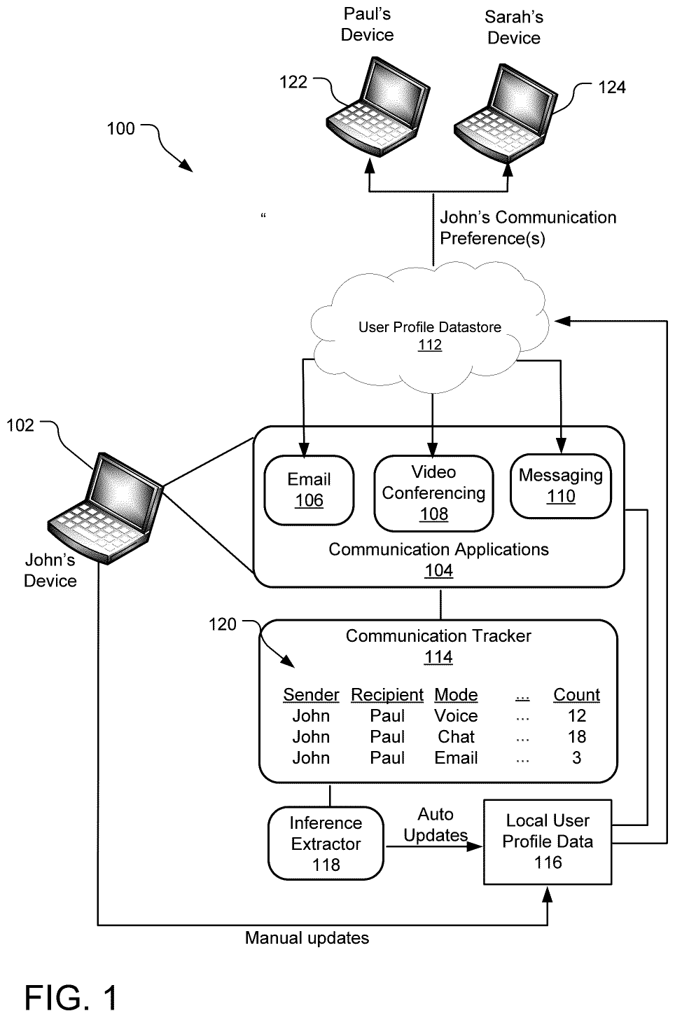

FIG. 1 illustrates an example communication system 100 that infers user communication preferences and exposes those preferences to other users interacting with a communication application. By example, FIG. 1 illustrates a personal device 102 (e.g., “John's device”) and various software components that execute either on the personal device 102 and/or that collect and utilize data collected on the personal device 102. Among these software components are various communication applications 104 that support different modes of communication with other users including, for example, email 106, video conference 108, and messaging 110 (e.g., text-based chat). Notably, some of the communication applications 104 may be multi-modal in the sense that multiple modes of communication are supported through a single application interface. For example, Microsoft Teams® provides a user interface through which a user can make voice calls, video calls, and engage in messaging (text chats). Other communication applications, such as certain email clients, are single-modal in the sense that they support a single mode of communication.

In one implementation, the communication applications 104 are account-based in the sense that a given account owner (e.g., John) logs into an associated communication account within each of the communication applications 104 in order to utilize some or all features of the application. For example, John logs into his account in Microsoft Outlook® (an email application) or on Microsoft Teams® (e.g., a communication application that integrates voice, video, and chat) by providing certain identifying information that is, in turn, verified by an application server or third-party authentication system associated with the application before John is permitted access to the account. In some implementations, a single account owner may have multiple different communication accounts that are each associated with a different one of the communication applications 104 executing on the user device.

In FIG. 1, the communication applications 104 are all configured to send data to and retrieve data from a same data source, a user profile datastore 112. Within the disclosed framework, a user's communication preferences are discovered, shared with user profile datastore, and then exposed to other users interacting with their own respective communication accounts to one or more of the communication applications 104. Notably, some implementations may provide for discovering and exposing a user's communication preferences within a single communication application while other implementations may provide for discovering and/or exposing the communication applications across multiple different communication applications.

The communication applications 104 each independently import and manage contact information in association with each existing communication account. For example, John may have a communication account with an email application 106 as well as a messaging application 110, and each these communication applications 104 maintains an address book-type feature that is populated with “contact cards” that each include contact and/or profile information for an associated one of John's contacts.

As used herein, an individual is a “contact” of a communication account owner if the communication application is configured to populate, maintain, and make accessible contact information for that individual within an active user session of the associated communication account. Notably, communication applications may be configured (e.g., by an account owner or enterprise administrator) to import contact information per different settings and rules. For example, a communication application may be configured to import contact card information for all users with accounts on a local network (e.g., all employees of an organization) and/or be configured to import contact card information for users that the account owner has previously corresponded with (e.g., including those external to the organization).

In general, a contact card may be understood as including at least a user identifier (e.g., such as a username or actual name identifying a particular user as well as a communication address that is usable to direct or route a communication to the user (e.g., an email address, an alias used for chatting, a phone number). In the disclosed system, the communication applications 104 are all configured to populate their respective contact cards with at least some contact information retrieved from the globally accessible user profile datastore (“user profile datastore 112”). The user profile datastore 112 is, for example, a cloud-based profile database system that includes profile data for various users.

In one implementation, each user profile within the user profile datastore 112 includes communication preference, such as information relating to a user's preferred mode of communication and/or the specific content preferences. Updates to profile data within the user profile datastore 112 are affected by “pushing” profile data collected on user devices to the user profile datastore. For example, one or more of the communication application(s) 104 on the personal device 102 may update local user profile data 116 for John, such as responsive to alterations to profile settings that John manually configures or responsive to preference inferences extracted by the communication system 100 (discussed further below).

Updated local user profile data 116 is, in turn, transmitted (e.g., by one of the communication applications 104 or by the inference extractor 118) to the user profile datastore 112 and these updates are made accessible to other instances of the communication applications 104 executing on other devices 122, 124. In the illustrated example, the devices 122 and 124 are owned by John's contacts, Paul and Sarah. When the local user profile data 116 is updated on John's device (the personal device 102), this information—including updated communication preferences—is pushed to the user profile datastore 112 and is ultimately downloaded to the devices 122, 124 and made accessible to Paul and Sarah through their respective communication accounts.

Although the local user profile data 116 is, in FIG. 1, shown external to the communication applications 104, this data may alternatively reside within one or more of the communication applications 104 and be transmitted directedly from such applications to the user profile datastore 112.

As mentioned above, the local user profile data 116 includes communication preferences of the associated account owner (John). Updates to these communication preferences may be manually specified the account owner (e.g., John), such as within configurable settings of a corresponding one of the communication applications 104 and/or inferred by software components of the communication system 100. In FIG. 1, communication preference inferences are extracted by actions jointly performed by a communication tracker 114 and an inference extractor 118.

The communication tracker 114 performs actions for tracking communication activities of a user that occur within channels provided by the user's communication accounts to one or more of the communication applications 104. The inference extractor 118 analyzes the tracked communication activities to extract communication preferences.

In different implementations, the communication tracker 114 tracks different types of information such as information relating to the origin, destination, and mode of each communication as well as to the content of these communications. By example, the communication tracker 114 is shown tracking the communication mode and parties involved in each of several communications initiated by John.

In this example, the communication tracker 114 keeps a counter in association with each different mode of communication utilized within a same participant group (e.g., sender/recipient). For example, a table 120 indicates that John has called Paul 12 times, text-chatted with Paul 18 different times, and emailed Paul three times since the start of corresponding interval represented by the illustrated table within the communication tracker 114. From this tracked information, the inference extractor 118 may infer that John's communication preferences for correspondence with Paul are, in descending order of preference: chat, voice, and email. Notably, this trend may be true across most or all of John's contacts. If so, a communication mode preference may be updated within the local user profile data 116 to indicate that, as a default, John's mode of communication preferences are, in descending order: chat, voice, and email regardless of sender identity.

Notably, the inference extractor 118 may, in the above example, determine that John's preference for chatting is with Paul is unique to Paul and/or to select individuals that share certain characteristics with Paul. For example, it may be that Paul has been designated as a “close” contacts (e.g., favorites), such as by manual action by John or due to a high volume of communications that are tracked between John and Paul. If John exhibits similar communication mode preferences with other contacts that share the same relationship status (close/favorite contact), a communication mode preference may be set to indicate that John's mode preference order of chat, voice, and email applies to this group of individuals but not to other users that do not have this “close” contact status.

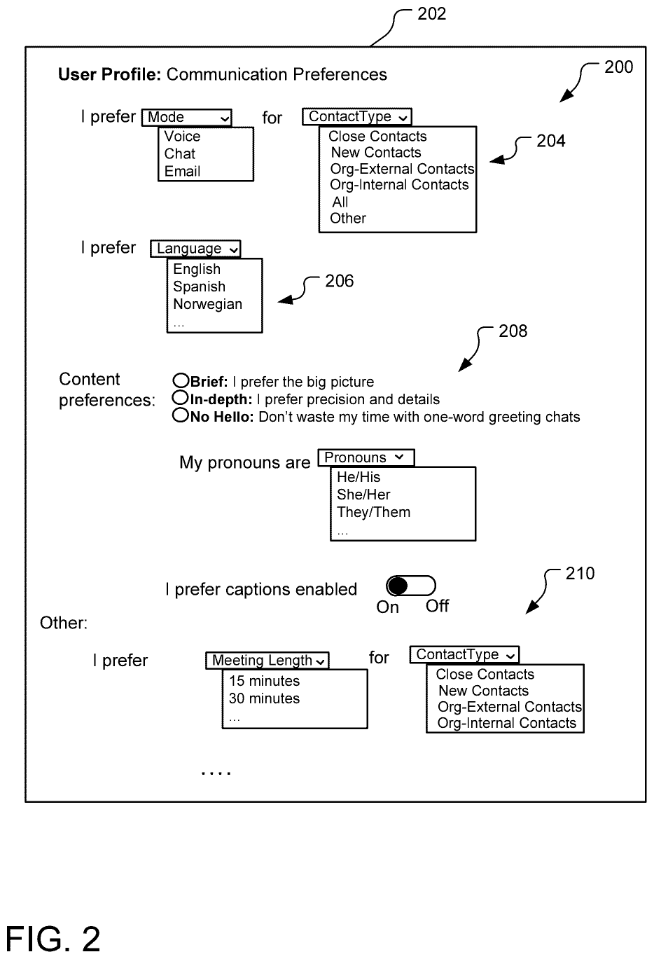

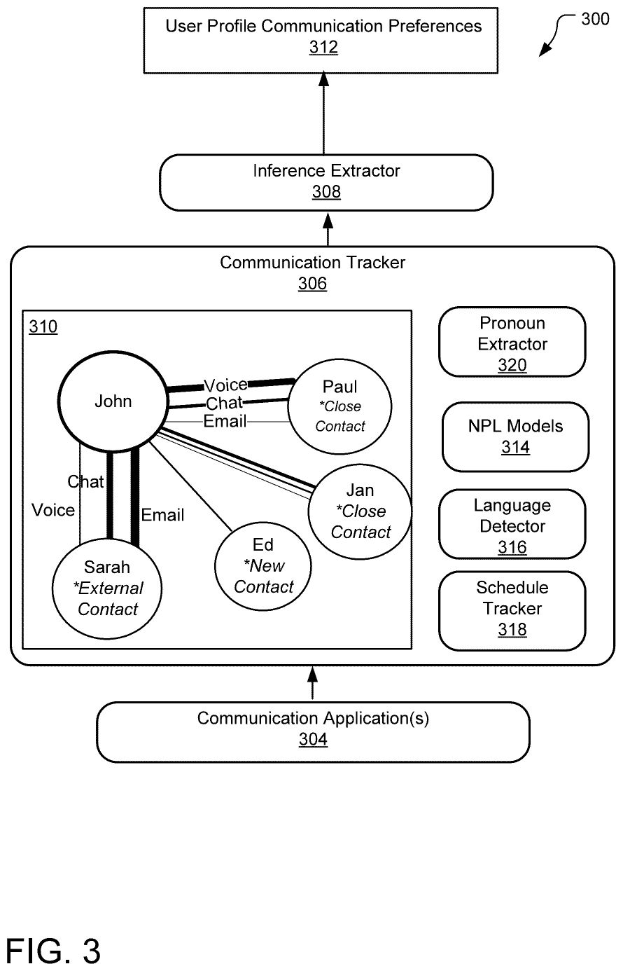

In another implementation, the communication tracker 114 performs actions to monitor and track the content of communications sent to and/or from a communication account. The inference extractor 118 extracts one or more communication preferences related to communication content (e.g., format or style). Non-exhaustive examples of further content-related communication preferences are discussed below with respect to FIGS. 2 and 3.

Various aspects of the communication tracker 114 and the inference extractor 118 may be cloud-based or executed locally on the personal device 102 associated with the user account for which the inferences are being extracted. In many systems, however, users can choose to “opt out” of sharing communication activity (e.g., with application servers or other external platforms). It is to be noted that in these types of systems, more useful inferences may be extracted when these software components are locally executed on the personal device 102 from which the account owner accesses their account(s) on the communication applications 104.

In one implementation, the communication applications 104 initiate queries to the user profile datastore 112 to self-populate their internally-maintained contact card information (e.g., contact cards) in association with each communication account.. For example, the email application 106 on John's device may query the user profile datastore 112 with contact identifiers (e.g., names of individuals that john has previously corresponded with by email) each time John re-launches (and logs in) to the application. In response to each query from one of the communication applications 104, the user profile datastore 112 sends the querying application profile information that is stored in associated with each received contact identifier.

The communication preference information received at the communication applications 104 from the user profile datastore 112 is, in one implementation, exposed to a user through a UI of the user's communication account to one of the communication applications 104. For example, John's communication preference information may be presented in association with John's contact card to Paul through a UI of Paul's email application and to Sarah through a UI of a voice/video and chat application. In this way, Sarah and Paul may be informed of John's communication mode preference at the time that they are considering initiating a communication to John, such when Sarah hovers her mouse cursor over a graphic corresponding to John's contact card and/or when John opens a new email window to begin composing a message.

FIG. 2 illustrates example communication preference fields 200 that may be set for a user (e.g., with values from a pre-populated list) and exposed to other users through a communication application.

The configurable communication preferences fields 200 represent an exemplary, non-exhaustive collection of different types of communication preference fields (e.g., communication preference fields 204, 206, 208, 210) that may be selectively set, by a user or automated process, and maintained as part of a user profile. Different implementations may provide for collecting less than all of the communication preference information shown and/or additional information in addition to or in lieu of some of the illustrated information.

Configurable communication mode preferences 204 allow a user to set a preferred communication mode (e.g., voice, chat email) for different types of contacts (e.g., close contacts, new contacts, org-external contacts, org-internal contacts, all contacts, or “other”). Other implementations may allow the user to specify an ordered list of preferred communication modes, either to use as a default across all contacts or for use in association with certain types of contacts (e.g., “ContactType” as shown). Language preferences 206 permit the user to specify one or more preferred languages including native language if different from the primary language that the individual converses in within the workplace.

Configurable content preference fields 208 characterize preferred format and message style for incoming communications. For example, a user may designate a message style preference for “brief” communications that provide a big picture/high-level overview or, instead, a message style preference for “in-depth” communications that include more precision and details. Other message style preferences may include a “no hello” option that advises users to avoid chat messages consisting of single-word greetings (e.g., indicating a preference for a more “to the point” conversation style.

Although not shown, other message style preferences may specify information such as preferred formatting settings (colors/sizes/fonts) for written text (e.g., “no yellow”) or other information such as preferred pronouns and/or information indicating sight or audio disabilities that may impact communications (e.g., “captions enabled” to ensure meeting captioning is always presented to an audio-impaired user).

Configurable communication preference fields 210 illustrated in FIG. 2 facilitate storage of a preferred meeting length, which may be helpful to a new contact that is requesting a meeting and unsure of how much time to schedule. For example, a busy executive may prefer to schedule brief (15-minute meetings) while others may prefer longer meetings and/or to set different meeting length preferences for different types of contacts as shown.

By example, the communication preference fields 200 are shown as being interactive and user-selectable within an application window 202. However, some implementations provide for automatically inferring one or more values of the communication preference fields 200. In various implementations, one or more of the communication mode preferences 204, language preferences 206, content preferences 208, and other preferences 210 (both shown and described) are automatically inferred by tracking and analyzing communications of a given user.

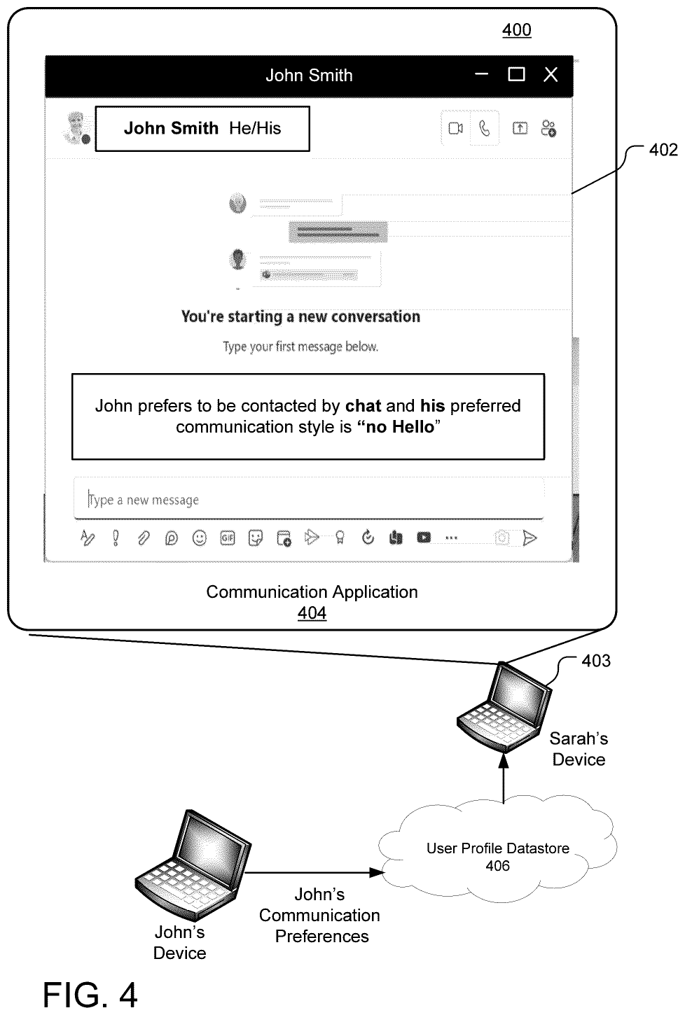

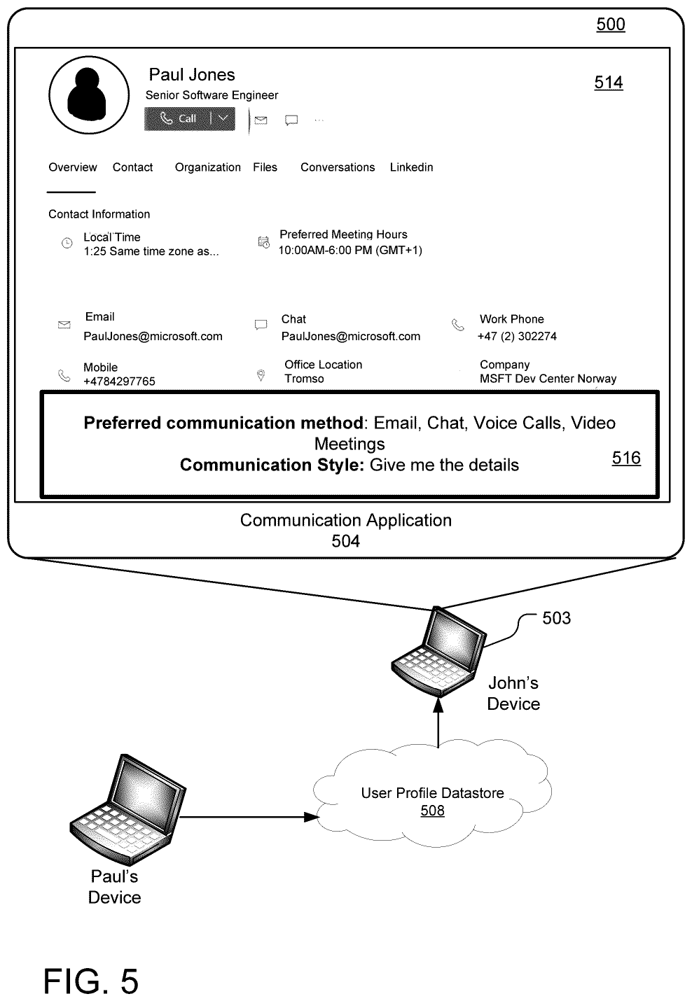

In one implementation, values for one or more of the communication preference fields 200 are inferred and automatically set within the user's profile without affirmative action of the user. In another implementation, the user is prompted to “accept” or “decline” a communication preference that is suggested based on the user's patterns of communication activity. Setting communication preferences in a structured taxonomy (e.g., as shown) facilitates programmed application of such preferences to communications on an individual and context-aware basis. For example, various communication applications utilizing such information can be programmed with rules for displaying different types of UI information in relation to communications associated with (e.g., directed to) a given user depending on the user's current set of communication preferences. By example, FIGS. 4 and 5 illustrate UI elements of communication interfaces that are designed to physically alter in presentation based on currently-elected user communication preferences of a user.

FIG. 3 illustrates aspects of another example system 300 that automatically infers user communication preferences and exposes such preferences to other users through a communication application. In one implementation, the system 300 tracks and analyzes communication activities of a user that are affected through user interactions with one or more communication applications 304 executing on a user's compute platform.

The system 300 includes a communication tracker 306 and an inference extractor 308 that perform at least some functions the same or similar to like-named components described with respect to FIG. 1.

The communication tracker 306 tracks communication activities occurring in association with one or more communication accounts of a user and aggregates data pertaining to the tracked activities. These communication tracker 306 may be an integrated component of one or more of the applications or separate software configured to communicate with API of the communication applications 304.

The inference extractor 308, which may also be a component of one of the communication applications 304 or a separate software component, analyzes the tracked, aggregated data to automatically extract communication preference inferences for the user and updates user profile communication preferences 312 to include the inferred communication preferences. For example, the inference extractor 308 may update one or more user communication preferences defined within a structured taxonomy such as that shown with respect to FIG. 2.

In FIG. 3, the communication tracker 306 and inference extractor 308 perform operations for detecting preferences pertaining to communication mode (e.g., how frequently the user communicates by each mode) as well as communication content (e.g., content, style, and/or other characteristics of the communications). In other implementations, the communication tracker 306 and inference extractor 308 are operable to perform actions for detecting fewer than all of the types of preferences discussed below with respect the system 300 and/or different preferences in addition to or in lieu of some described herein.

In FIG. 3, information collected by the communication tracker 306 is shown assembled into a people graph 310. The people graph 310 may be understood as being a portion of a much larger graph that is, for clarity of concept, visually condensed to show a small number of people and represent a small number of correspondences. In this example, the user is “John.” John logs into various communication applications 304 on his personal device, and the communication tracker 306 monitors communications that John initiates and/or receives to compile the people graph 310 over a running interval. The people graph 310 includes nodes representing “people” (e.g., the user, john, as well as each of multiple contacts that John has communicated with through one or more of the communication applications 304). Edges between the nodes includes characteristics of communications. In FIG. 3, the edges shown all correspond to modes of communication. However, the edges may in some implementations embody characteristics related to content of each communication as well. Each edge has an assigned edge weight (e.g., illustrated roughly by line thickness) that corresponds to the frequency or volume of the characteristic represented by the edge. Recording such activity data over time allows a broad range of inferences of how both individual users communicate, as well as how groups of users communicate together.

By example, the illustrated edges of the people graph 310 each correspond to a communication mode, and the edge weight (e.g., line thickness) increases in proportion to the number of communications that have been conducted between the associated users that are of the associated communication mode. For example, the people graph 310 illustrates that John communicates with Paul (a close contact) primarily by voice calls (audio-only or audio-video calls) and communicates with Sarah (an org-external contact) primarily by email. Notably, the people graph 310 is just an example visual of the type and usefulness of information that could be collected by the communication tracker 306. Information within the people graph 310 could also be represented as a table or in other form (e.g., the people graph is a visual aid representing tabulating information).

When analyzing the information represented within the people graph 310, the inference extractor 308 extracts the above-described inferences as communication preferences. For example, the inference extractor 308 may determine that John has a preference for voice chatting with Paul—either as an individual and/or with all contacts having a characteristic in common with Paul. Notably, Paul is one of John's “close contacts” which is, for example, a setting designated either manually by John or automatically by the system based on the frequency and/or volume of communications between John and Paul. If an analysis of the people graph 310 reveals that “voice” is the dominant communication mode for a threshold number (e.g., 80% or more) of the communications that John initiates with his close contacts, “voice” may be set as a communication preference for the “close contacts” grouping. Similar preferences may likewise be inferred with respect to other groups of contacts having some recognizable commonality. If, for example, the inference extractor 308 detects that John initiates a threshold number (e.g., 80%) of communications with “new contacts” by email, the inference extractor 308 may infers a communication preference for email communications with “new contacts” of John (e.g., users that have not previously communicated electronically with John).

Using the general methodology described above, the inference extractor 308 can infer communication mode preferences with respect to individual contacts and contacts characterized by a given group or type.

In FIG. 3, the communication tracker 306 also tracks certain characteristics of communication content to facilitate the inference of preferences relating to communication content. These characteristics of communication content may be collected and organized in a variety of ways such as in a table independent of the mode content data or by way of additional edges in the people graph 310. For example, additional edges extending between each pair of nodes (e.g., John and Paul) may each correspond to a content characteristic with an edge weights representing the volume of communications between the two users that embody the given content characteristic.

The communication tracker 306 includes one or more natural language processing (NLP) models 314 that analyze content of each communication and to characterize aspects of the content. For example, a trained NLP model may analyze the body of an email and characterize the email as either “brief” (e.g., short) or detailed (e.g., long) (e.g., respectively corresponding to the content preferences for “brief” and “in-depth” shown with respect to FIG. 2). In other implementations, rule-based algorithms may be employed to make the same or similar characterizations.

The communication tracker 306 of FIG. 3 also includes a language detector 316. The language detector 316 is a software tool that analyzes written and/or spoken communications to determine language. This information may also be tracked in edges of the people graph 310, or by other suitable tracking mechanisms (e.g., counters, database tables). For example, there may exist a graph edge representing “English language” that has an edge weight that increases in proportion to the percentage of English-language communications between the associated pair of users. When this edge weight satisfies predefined criteria (e.g., exceeds a threshold) the inference extractor 308 may determine that the two corresponding users (e.g., John and Paul) have a preference for communicating in English. Using the same or similar methodology, the inference extractor 308 may further determine that John communicates in Norwegian with work contacts that are based in Norway. Such a preference may be useful to alert other users based in Norway (current and potential future contacts of John) that John is capable of conversing in their native language.

The communication tracker 306 of FIG. 3 also includes a pronoun extractor 320. The pronoun extractor 320 is designed to extract pronouns from communications and analyze context surrounding each pronoun in an effort to identify a user that each pronoun is used in reference to. Extracted and tabulated pronoun information can then be pushed to a global profile datastore (e.g., the user profile datastore 112 of FIG. 1) where it is made available for download to populate the corresponding user's contact card within different instances of the communication applications 304—either immediately, or conditionally responsive to review by the user that the pronouns were used in reference to. For example, the pronoun extraction tool on John's device may determine that John, Paul, and Jan frequently collaborate as a group. When John and Paul refer to “Jan” in the third person, the pronoun extraction tool detects pronouns used in reference to Jan and adds them as “suggested pronouns” to Jan's profile information residing in a global profile datastore (not shown). In this scenario, the suggested pronouns may be made automatically available for import to contact cards of the communication applications 304 executing on various user devices or available conditionally for such import, such as after Jan has reviewed and accepted the suggested pronouns.

In still another implementation, the communication tracker 306 includes an NLP model or other tool for text or audio/speech analysis that monitors the user's outgoing messages to detect aspects of the user's style. For example, the user may often start a chat message conversation with a “hello” and wait for a response. In this case, the inference extractor 308 may indicate that the user has a “hello-preferred” style (or, alternatively, a “no hello” style if the user tends to skip the greeting formality). This information can be used to automatically set a “hello” or “no hello” preference, such as the preference corresponding to the radio button illustrated within content preferences 208 of FIG. 2.

The communication tracker 306 is further shown to include a scheduling tracker 318. The scheduling tracker 318 performs tasks for collecting data relating to schedule-driven communication preferences. In one implementation, the scheduling tracker 318 accesses the user's calendar data to determine information such as typical (e.g., average or median) meeting length. If the user commonly meets with users internal to his organization for 30 minute chunks of time, the inference extractor 308 may extract a “30-minute” meeting length preference for such individuals that is added to the user profile communication preferences 312. Consequently, when an organization-internal user opens a window to schedule a meeting with John, the user may be presented with a notification that John prefers 30 minute meetings or otherwise suggest that the user schedule a 30-minute time block.

In some implementations, the schedule tracker 318 accesses calendar data on the user's device to dynamically determine temporary, schedule-driven communication preferences based on real-time observations. In one implementation, calendar data is selectively accessed when the inference extractor 308 detects an atypical pattern in the user's outgoing communications. For example, the communication tracker 306 may detect that the user has sent 22 short emails in the past 48 hours and has not accepted or placed any phone calls. The inference extractor 308 may compare this recent (past 48 hour) data to the prior 2 months of batched communication activity for the user and determine that the user's communication in the past 48-hour data deviates from normal communication patterns.

In the above example scenario, the schedule tracker 318 may reference the user's calendar data to see identify recent or upcoming events that might explain why the user is communicating atypically. If such an event is identified, this is conveyed to the inference extractor 308 and the inference extractor 308 may automatically set or suggest a temporary change in the user's communication preferences. A time frame for the temporary change in the user communication preferences may be set by default or by recommendation of the schedule tracker 318 based on the events identified on the user's calendar.

If, in the above example, the schedule tracker 318 determines that the user just returned from a 2-week vacation 48 hours prior, this provides a plausible explanation for the user's atypical communication activity (e.g., the user is working hard to catch-up on emails and doesn't want to be disturbed). In this scenario, the user's default communication mode preference may be changed from phone to email for a set time block (e.g., 24 hours) or until the communication tracker 306 determines that the user's communications resume their normal patterns. Alternatively, if in the above example the schedule tracker 318 detects a large block of upcoming meetings, the user's brief, email-only activity may indicate that the user is hard at work getting ready for the upcoming events. In this case, the user's default communication mode preference may be changed from phone to email until after the upcoming events have occurred.

In one implementation, the inference extractor 308 updates preference inferences based on communication events detected in real-time. For example, the communication tracker 306 may keep counters in association with certain types of communication activity, and the inference extractor 308 may dynamically update (or suggest an update to) a communication preference when the counter data satisfies set criteria, such as when a threshold is met or surpassed. For instance, the inference extractor 308 may implement a rule that sets a user's preferred communication mode to whatever mode accounts for a largest percentage of the user's total communications in a running interval of set length (e.g., the past two months). When the user places a phone call that effectively shifts that largest percentage of communications from email to phone, the inference extractor 308 may automatically change or suggest a change to the user's preferred mode of communication from email to phone.

In another implementation, the inference extractor 308 initially sets the communication interferences based on an analysis of batched data over a set interval (e.g., the past 2 months) and re-evaluates the preferences periodically, such as by analyzing the past two months of data at the start of each month to determine if the newer user activity in the past month triggers changes (e.g., based on set rules) to existing preferences.

Notably, there is an advantage to using some batched data over a longer interval, as this allows for collection of enough datapoints to make a more accurate assessment of the user's habits with respect to communication mode and style despite variations to those habits that may dominate certain short-terms trends, which tend to have a higher impact on preference inferences based on more recent, real-time analysis. However, reliance on exclusively long-term trend data may in some cases be undesirable since long-term preferences are not necessarily the best prediction of current preferences, which may vary based on current events. A hybrid approach, as described above, may be offer a convenient blend of reliability and flexibility.

In one implementation, software components shown and described with respect to FIG. 3 are locally executed on a user device along with the communication application(s) 304. In other implementations, some of the illustrated software components are executed remotely, such as at one or more a cloud-based application servers.

In one implementation, the inference extractor 308 automatically updates user profile communication preferences 312 to incorporate inferred communication preference(s). In another implementation, the inference extractor 308 communicates within an API of one of the communication applications 304 to present a prompt within a UI of the application to request that the user accept or decline a suggested communication preference that has been inferred by the inference extractor 308.

As described with respect to FIGS. 1 and 2, updated information within the user profile communication preferences 312 may be transmitted to a global user profile datastore (e.g., the user profile datastore 112 of FIG. 1) and thereby made accessible to different instances of the communication applications 304, such as to serve as a data source from which to populate contact card information for contacts established in association with different user accounts.

FIG. 4 illustrates example communication preferences of a first user (e.g., John) displayed on a user interface 400 of a second user (e.g., Sarah) while the second user is logged into and interacting with a communication application 404 on a personal device 403. In this example, John and Sarah have not previously communicated electronically, but John is an employee in Sarah's organization. Sarah's communication application 404 is configured (per administration-level settings) to automatically import contact card information for all contacts within the organization and also for Sarah's own personal contacts, some of which may be external to the organization. The communication application 404 retrieves this contact card information from a global profile datastore 406, which includes communication preference information obtained by any of the methods and techniques described above with respect to FIG. 1-3.

When Sarah opens a chat window 402 within the communication application to begin corresponding with John (a person she has not previously corresponded with), communication preference information from John's contact card is presented within the chat window 402 on Sarah's display. Specifically, the chat window 402 displays the message “John prefers to be contacted by chat and his communication style is ‘No Hello.’” In this example, John's contact card information indicates a preference to be contacted by “Chat” (rather than email or phone), a preference for the his/he pronouns, and a preference indicating a communication style of “no hello.” (As described with respect to FIG. 2, the “no hello” communication style is merely exemplary but refers to a preferred chat style that skips greeting formalities and gets to the point more quickly).

Because John's communication preferences are presented to Sarah automatically at the time that Sarah is interacting with John's contact card, Sarah can tailor aspects of her outgoing communication to comply with John's preferences, thereby ensuring that her correspondence is less burdensome to John.

In various implementations, the communication applications leveraging the herein disclosed communication-preference-exposing technology may present communication preferences of a user's contact (e.g., John) to the user (e.g., Sarah) in various ways. In one implementation, communication preference information of a user's contact is presented when the user performs some action that triggers an interaction with the contact card of the contact. For instance, in the example of FIG. 3, Sarah may interact with John's contact card when she clicks on an icon within John's contact card that opens the chat window 402 with John as a designated recipient of the chat. In another implementation, Sarah interacts with John's contact card when she hovers over an image associated with the contact card (e.g., John's avatar or photo). In still another implementation, Sarah interacts with John's contact card by typing John's name (or an email address or chat alias) in the addressee field of an outgoing communication.

FIG. 5 illustrates further example communication preferences of a first user (e.g., Paul) displayed on a user interface 500 of a second user (e.g., John) while the second user is logged into and interacting with a communication application 504 on a personal device 503. In this example, the communication application 504 maintains a contact card for Paul in association with John's account to the communication application. Whenever John is logged into his account on the communication application 504, he is able to access a contact card for each of his contacts that includes communication preference information that has been retrieved from a global profile datastore 506, such as by any of the methods and techniques described above with respect to FIG. 1-4.

When John interacts with UI content corresponding to Paul's contact card 514 (e.g., a graphic including Paul's name, image, avatar), the contact card 514 is displayed. In this case, Paul's communication preferences are presented in a text box 516 that reads “Preferred communication method: Email, Chat, Voice calls, Video Meetings,” and the order is indicative of a preference from most preferred to least preferred. The text box 516 further reads “Give me the details” which may, for example, correspond to the “in-depth” radio button shown among the content preferences 208 in FIG. 2.

Because Paul's communication preferences are exposed to John in this way, John can tailor aspects of his outgoing communication to comply with John's preferences, such as by writing an in-depth email rather than calling Paul.

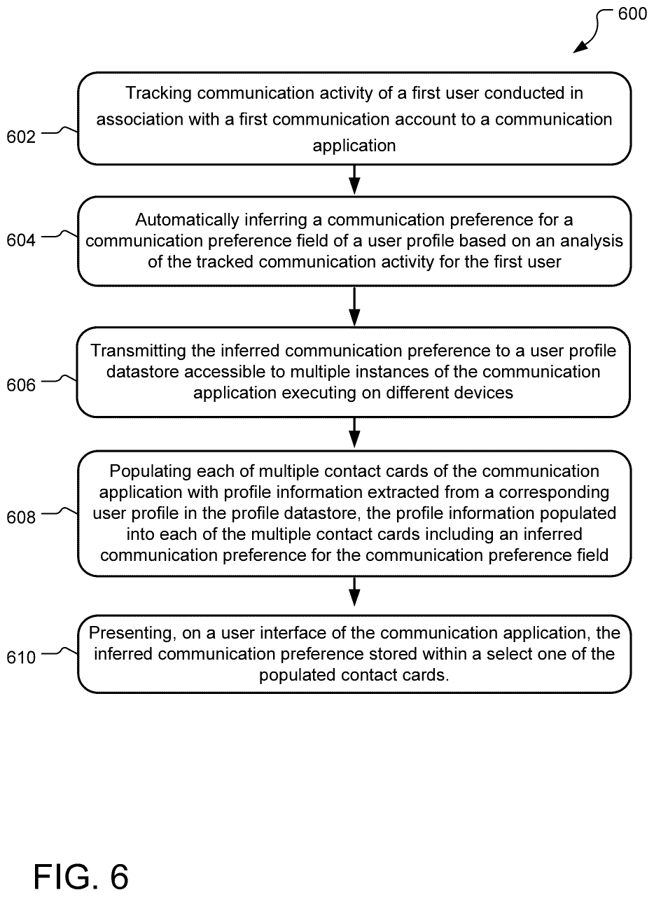

FIG. 6 illustrates example operations 600 for inferring and exposing communication preferences of multiple users. The operations 600 includes a tracking operation 602 that tracks communication activity of a first user conducted in association with a first communication account to a communication application (e.g., emails, chats, calls, meetings).

An inference operation 604 analyzes the tracked communication activity for the first user and based on the analysis, automatically infers a communication preference for a communication preference field within a user profile of the first user. For example, the inference operation may infer a communication preference “email” with respect to a communication preference field “preferred mode of communication.” Other examples of communication preference fields are shown and described herein with respect to FIG. 2 while other examples of inferences for such fields are described herein with respect to FIG. 3.

A transmitting operation 606 transmits the inferred communication preference of the first user to a user profile datastore accessible to multiple instances of the communication executing on different devices. For example, the user profile datastore is a cloud-based datastore that the communication application uses to populate contact card information stored in association with each different communication account (user account).

A populating operation 608 populates each of multiple contact cards of the communication application with profile information extracted from a corresponding user profile in the profile datastore. The profile information populated into each of the multiple contact cards includes an inferred communication preference for the communication preference field. For example, each populated contact card includes the preferred mode of communication for the associated user.

A presentation operation 610 presents, on a user interface of the communication application, the inferred communication preference stored within a select one of the populated contact cards. For example, the inferred communication for a contact card of a first user is presented to a second user when the second user hovers over or clicks on the contact card of the first user.

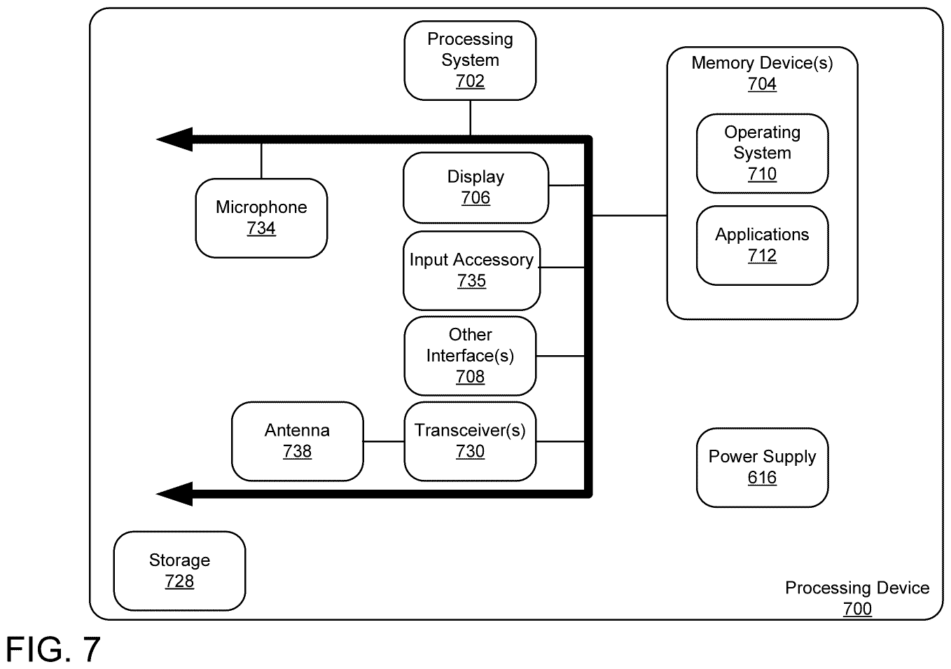

FIG. 7 illustrates an example schematic of a processing device 700 suitable for implementing aspects of the disclosed technology. The processing device 700 includes a processing system 702, memory device(s) 704, a display 706, and other interfaces 708 (e.g., buttons). The processing system 702 includes one or more processors (CPUs, GPUs, etc.). The memory 704 generally includes both volatile memory (e.g., RAM) and non-volatile memory (e.g., flash memory). An operating system 710 may reside in the memory 704 and be executed by the processing system 702.

One or more applications 712 (e.g., the communication applications 104, the communication tracker 114, or the inference extractor 118) are loaded in the memory 704 and executed on the operating system 710 by the processing system 702. The applications 712 may receive inputs from one another as well as from various input local devices such as a microphone 734, and an input accessory 735 (e.g., keypad, mouse, stylus, touchpad, gamepad, joystick).

Additionally, the applications 712 may receive input from one or more remote devices, such as remotely-located smart devices, by communicating with such devices over a wired or wireless network using more communication transceivers 730 and an antenna 738 to provide network connectivity (e.g., a mobile phone network, Wi-Fi®, Bluetooth®). The processing device 700 may also include one or more storage devices 728 (e.g., non-volatile storage). Other configurations may also be employed. The processing device 700 further includes a power supply 716, which is powered by one or more batteries or other power sources and which provides power to other components of the processing device 700. The power supply 716 may also be connected to an external power source (not shown) that overrides or recharges the built-in batteries or other power sources.

The processing device 700 may include a variety of tangible computer-readable storage media and intangible computer-readable communication signals. Tangible computer-readable storage can be embodied by any available media that can be accessed by the processing device 700 and includes both volatile and nonvolatile storage media, removable and non-removable storage media. Tangible computer-readable storage media excludes intangible and transitory communications signals and includes volatile and nonvolatile, removable and non-removable storage media implemented in any method or technology for storage of information such as computer readable instructions, data structures, program modules or other data. Tangible computer-readable storage media includes RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the processing device 700. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, intangible communication signals include wired media such as a wired network or direct-wired connection, and wireless media such as acoustic, RF, infrared, and other wireless media.

The following summary provides a non-exhaustive set of illustrative examples of the technology set forth herein.

(A1) According to a first, aspect, some implementations include a method of inferring and exposing a user's communication preference. The method includes tracking, over a first period of time, communication activity of a first user conducted in association with a first communication account to a communication application. The method further includes automatically inferring a communication preference for a communication preference field of a user profile of the first user based on an analysis of the communication activity tracked for the first user and transmitting the inferred communication preference of the first user to a user profile datastore. The user profile datastore is accessible to multiple instances of the communication application executing on different devices. The method further provides for populating each of multiple contact cards of the communication application with an inferred communication preference extracted from a corresponding user profile in the user profile datastore and presenting, on a user interface of the communication application, the inferred communication preference stored within a select one of the populated contact cards.

The method of A1 is advantageous because it facilitates detection of a user communication preference without affirmative action of the user and further facilitates exposure of the inferred communication preference to other users, thereby indirectly increasing the number of communications that the user receives that are compliant with the user's communication preference and improving the user experience.

(A2) In some implementations of A1, the method further includes presenting the inferred communication preference of the select one of the populated contact cards responsive to detecting an interaction of the first user with the select one of the populated contact cards. The method of A2 is advantageous because it facilitates auto-presenting contact preference information of a first user to a second user at a time that the second user is contemplating initiating a communication to the first user. When presented in this manner, the communication preference information may serve as a convenient reminder or tip to the second user, thereby mitigating the burden that might otherwise arise if affirmative action(s) were needed to locate the communication preference information.

(A3) In some implementations of A2 or A3, the inferred communication preference includes a preferred mode of communication. The method of A3 is advantageous because sharing of a communication mode preference helps to ensure that the user is more likely to be contacted according to their preferred communication mode.

(A4) In some implementations of A2-A4, the inferred communication preference includes at least one of: a preferred spoken language, a preferred pronoun, and a preferred message style. The method of A4 is advantageous because sharing of content preferences helps to maximize the ease of comfort of the user receiving the communication.

(A5) In some implementations of A2-A5, the tracking of the communication activity is performed locally on a same user device that executes the communication application. The method of A5 may be advantageous because it facilitates communication preference sharing for users that have opted out of sharing certain activity information with application servers.

(A6) In some implementations of A2-A5, the inferred communication preference specifies a group of users with a shared characteristic. The method of A6 is advantageous because it facilitates auto-configuration of communication preferences that vary based on parties involved in the communication.

(A7) In some implementations of A2-A6, the method further comprises: detecting additional communication activity of the first user conducted over a second period of time; determining that the additional communication activity of the first user is atypical in comparison to the communication activity tracked over the first period of time; and temporarily altering the inferred communication preference within the user profile of the first user in response to the determination. (A8) In some implementations of A2-A7, the method further comprises accessing calendar data of the first user; and temporarily altering the inferred communication preference for a period of time selected based on a scheduled event included within the calendar data. The methods of A7 and A8 are advantageous because they allow for dynamic shifts auto-configured communication preferences based on real-time events that may temporarily change those preferences.

In another aspect, some implementations include a computing system that infers a user's communication preferences based on tracked communication activity and that exposes those preferences to other users. The computing system includes hardware logic circuitry that is configured to perform any of the methods described herein (e.g., methods A1-A8).

In yet another aspect, some implementations include a computer-readable storage medium for storing computer-readable instructions. The computer-readable instructions, when executed by one or more hardware processors, perform any of the methods described herein (e.g., methods A1-A8).

Some implementations may comprise an article of manufacture. An article of manufacture may comprise a tangible storage medium (a memory device) to store logic. Examples of a storage medium include one or more types of processor-readable storage media capable of storing electronic data, including volatile memory or non-volatile memory, removable or non-removable memory, erasable or non-erasable memory, writeable or re-writeable memory, and so forth. Examples of the logic include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture stores executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain operation segment. The instructions may be implemented using any suitable high-level, low-level, object-oriented, visual, compiled and/or interpreted programming language.

The logical operations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of example implementations.

What is claimed is:

1. A method comprising:
tracking, over a first period of time, communication activity of a first user conducted in association with a first communication account to a communication application;
automatically inferring a communication preference for a communication preference field of a user profile of the first user based on an analysis of the communication activity tracked for the first user;
transmitting the inferred communication preference of the first user to a user profile datastore, the user profile datastore being accessible to multiple instances of the communication application executing on different devices;
populating each of multiple contact cards of the communication application with profile information extracted from a corresponding user profile in the user profile datastore, the profile information populated into each of the multiple contact cards including an inferred communication preference for the communication preference field; and
presenting, on a user interface of the communication application, the inferred communication preference stored within a select one of the populated contact cards.

2. The method of claim 1, wherein the method further comprises:
presenting the inferred communication preference of the select one of the populated contact cards responsive to detecting an interaction of the first user with the select one of the populated contact cards.

3. The method of claim 1, wherein the inferred communication preference includes a preferred mode of communication.

4. The method of claim 1, wherein the inferred communication preference includes at least one of: a preferred spoken language, a preferred pronoun, and a preferred message style.

5. The method of claim 1, wherein the tracking of the communication activity is performed locally on a same user device that executes the communication application.

6. The method of claim 1, wherein the inferred communication preference specifies a group of users with a shared characteristic.

7. The method of claim 1, further comprising:
detecting additional communication activity of the first user conducted over a second period of time;
determining that the additional communication activity of the first user is atypical in comparison to the communication activity tracked over the first period of time;
temporarily altering the inferred communication preference within the user profile of the first user in response to the determination.

8. The method of claim 7, further comprising:
accessing calendar data of the first user; and
temporarily altering the inferred communication preference for a period of time selected based on a scheduled event included within the calendar data.

9. A system comprising:
a communication application;
a communication tracker stored in memory that tracks, over a first period of time, communication activity of a first user conducted in association with a first communication account to the communication application;
an inference extractor stored in the memory that automatically infers a communication preference for a communication preference field associated with a user profile of the first user based on an analysis of the communication activity tracked for the first user;
wherein the communication application:
transmits the inferred communication preference of the first user to a user profile datastore, the user profile datastore being accessible to multiple instances of the communication application executing on different devices;
populates each of multiple contact cards of the communication application with profile information extracted from a corresponding user profile in the user profile datastore, the profile information populated into each of the multiple contact cards including an inferred communication preference for the communication preference field; and
presents, on a user interface, the inferred communication preference stored within a select one of the populated contact cards.

10. The system of claim 9, wherein the communication application presents the inferred communication preference of the select one of the populated contact cards responsive to detecting an interaction of the first user with the select one of the populated contact cards.

11. The system of claim 9, wherein the inferred communication preference includes a preferred mode of communication.

12. The system of claim 9, wherein the inferred communication preference includes at least one of: a preferred spoken language, a preferred pronoun, and a preferred message style.

13. The system of claim 9, wherein the communication tracker is executed by a same user device that executes the communication application.

14. The system of claim 9, wherein the inferred communication preference specifies a group of users with a shared characteristic.

15. The system of claim 9, wherein the communication tracker is further configured to detect additional communication activity of the first user conducted over a second period of time, and
wherein the inference extractor is further configured to determine that the additional communication activity of the first user is atypical in comparison to the communication activity tracked over the first period of time and temporarily alter the inferred communication preference within the user profile of the first user in response to the determination.

16. The system of claim 9, wherein the inference extractor is provided with calendar data of the first user, and wherein a time period for temporarily alteration of the inferred communication preference is selected based on a scheduled event included within the calendar data.

17. A tangible computer-readable storage media encoding computer-executable instructions for executing a computer process comprising:
accessing a user profile datastore to retrieve an inferred communication preference from each of a plurality of user profiles;
storing within each of a plurality of contact cards of a communication application the inferred communication preference downloaded from a corresponding one of the plurality of user profiles in the user profile datastore;
detecting, via a user interface of the communication application, a user interaction with a user interface element associated with a select one of the contact cards; and
responsive to detecting the user interaction, presenting, on the user interface of the communication application, the inferred communication preference stored within in the select one of the contact cards.

18. The tangible computer-readable storage media of claim 17, wherein the inferred communication preference includes a preferred mode of communication.

19. The tangible computer-readable storage media of claim 17, wherein the inferred communication preference includes at least one of: a preferred spoken language, a preferred pronoun, and a preferred message style.

20. The tangible computer-readable storage media of claim 17, wherein the inferred communication preference specifies a group of users with a shared characteristic.
